(19) United States
(12) Patent Application Publication
(10) Pub. No.: US 2006/0086093 A1
(43) Pub. Date: Apr. 27, 2006

(54) Variable-section turbomachine nozzle with a one-piece control lever support

(75) Inventors: Mathieu Dakowski, Sucy En Brie (FR); Sylvain Duval, Tournan En Brie France (FR); Olivier Kreder, Chailly En Biere (FR); Romain Nicolas Lunel, Moissy Cramayel (FR); Emmanuel Christophe Mandet, Echouboulains (FR); Guillaume Sevi, Ivry Sur Seine (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SNECMA, Paris (FR)

(21) Appl. No.: 11/248,329

(22) Filed: Oct. 13, 2005

(30) Foreign Application Priority Data
Oct. 26, 2004 (FR) 0411394

(51) Int. Cl. F02K 1/12

(52) U.S. Cl. 60/771; 239/265.39

(57) ABSTRACT

A variable-section nozzle for a turbomachine, the nozzle comprising a plurality of moving flaps mounted on the downstream end of an annular casing of the turbomachine, a moving flap control system comprising control levers each associated with a respective moving flap and at least one actuator for actuating the control levers, and a plurality of pairs of arms each forming a control lever support, the arms of each support being secured both to the casing and to a control lever, each pair of arms forming a control lever support being formed as a single piece.

### BACKGROUND OF THE INVENTION

The present invention relates to the general field of variable-section nozzles for turbomachines, and more particularly it relates to nozzles constituted by a plurality of moving flaps making up a ring.

A conventional architecture for a variable-section nozzle of a turbomachine is shown in part in FIG. 4. In that type of architecture, the nozzle 100 comprises in particular a plurality of moving flaps 102, 102′ mounted on a downstream end of an annular casing 104 of the turbomachine. The moving flaps thus form a ring.

The moving flaps 102, 102′ are actuated by a control system so as to vary the profile of the primary stream from the turbomachine (i.e. its exhaust section). The control system comprises control levers 106, 106′ each associated with a respective moving flap 102, 102′, and at least one actuator 108 for actuating the control lever. Swivelling-fork type connections 110 interconnect the control levers 106, 106′ in order to synchronize movements of the moving flaps 102, 102′.

The nozzle 100 also has a plurality of pairs of arms (or splints) each forming a support 112, 112′ for a respective control lever 106, 106′. The two arms 112a, 112b and 112′a, 112′b of each support 112, 112′ are secured to the casing 104, and at their downstream ends, they are secured to a respective control lever via a spool 114, 114′.

The spool 114, 114′ of each control lever support 112, 112′ is mounted between the two arms of a given support, at the downstream ends thereof. Such a spool is hinged about a shaft screwed between the two arms so as to adjust the variable section of the nozzle.

When assembling such an architecture for a variable-section nozzle, the various component parts of the nozzle must be assembled in a specific order in order to ensure perfect continuity (leaktightness) of the primary stream while the nozzle is in operation, with this applying regardless of the section of its opening.

Depending on the accuracy and the order in which the component parts of the nozzle are assembled, deformation can appear in operation to a greater or lesser extent, giving rise to considerable differences in the extent to which the various moving flaps are deflected, i.e. in the angle between each flap and the axis of the turbomachine.

This accuracy in assembly is of particular importance for the arms (or splints) forming the supports of the control levers. As shown in FIG. 5, while these parts are being mounted, an axial offset 116 can appear between two adjacent control lever supports 112, 112′. An axial offset 118 between two arms 112′a and 112′b of a single control lever support 112′ can also lead to inaccuracy in the assembly of the nozzle (the support then forms a non-rectangular parallelogram). In operation, such offsets 116, 118 can lead to leakage in the vicinity of the spool 114, 114′ of the control lever.

### OBJECT AND SUMMARY OF THE INVENTION

The present invention seeks specifically to remedy such drawbacks by proposing a variable-section nozzle that is simpler to assemble, thus making it possible to ensure perfect continuity of the primary stream in operation.

According to the invention, these objects are achieved by a variable-section nozzle for a turbomachine, the nozzle comprising a plurality of moving flaps mounted on the downstream end of an annular casing of the turbomachine, a moving flap control system comprising control levers each associated with a respective moving flap and at least one actuator for actuating the control levers, and a plurality of pairs of arms each forming a control lever support, the arms of each support being secured both to the casing and to a control lever, wherein each pair of arms forming a control lever support is formed as a single piece.

As a result, all risk of inaccuracy during assembly of the nozzle is avoided. In addition, assembling the moving flaps of the nozzle to the casing is simplified. The use of a single part (a one-piece part) for the control lever supports reduces the extent to which tolerances can accumulate during assembly, thereby contributing to avoiding any risk of leakage between the various moving flaps of the nozzle. Another result of the control lever support being of a one-piece structure is a reduction in assembly costs and also in the costs of manufacturing the supports.

According to a particular characteristic, each control lever support further comprises an upstream spacer secured between the upstream ends of each arm.

Under such circumstances, the upstream spacer of each control lever support is preferably of one-piece construction with the arm of the support.

The actuator(s) can be mounted on the casing via one of the control lever supports.

The present invention also provides a control lever support for a moving flap of a variable-section nozzle of a turbomachine, as defined above.

### BRIEF DESCRIPTION OF THE DRAWINGS

Other characteristics and advantages of the present invention appear from the following description given with reference to the accompanying drawings which show an embodiment having no limiting character. In the figures:

FIG. 1 is a fragmentary perspective view of a variable-section nozzle of the invention;

FIGS. 2 and 3 are perspective views of control lever supports for the FIG. 1 nozzle;

FIG. 4, described above, is a fragmentary perspective view of a variable-section nozzle of the prior art; and

FIG. 5, described above, is a plan view of the control lever support of the FIG. 4 nozzle.

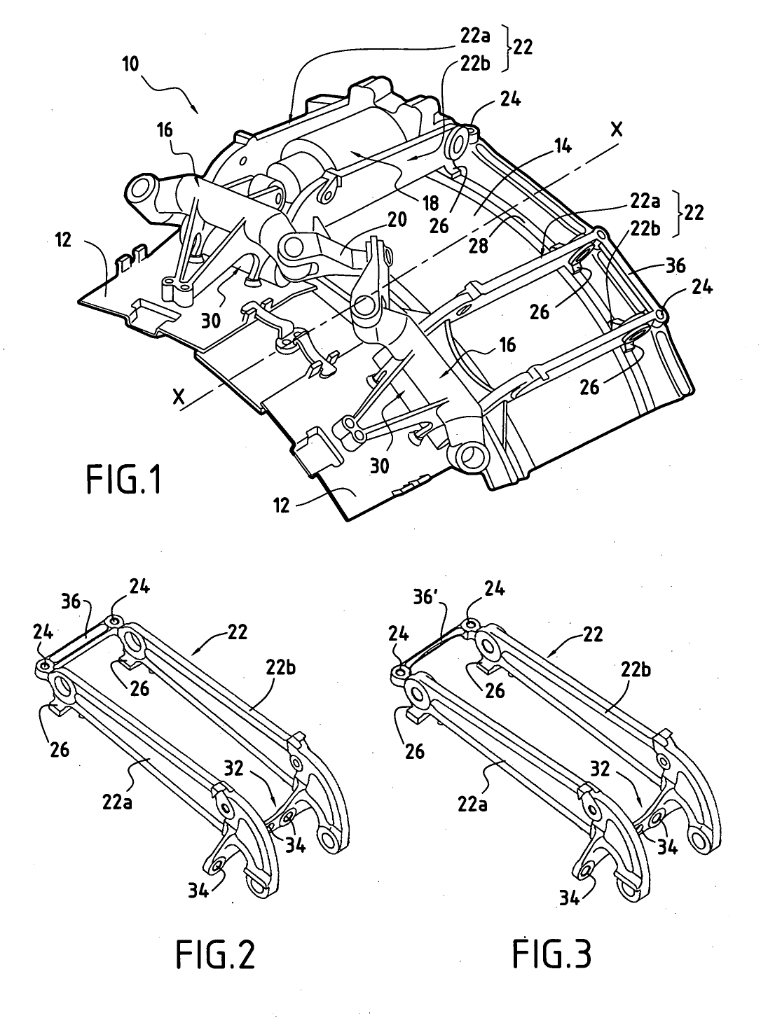

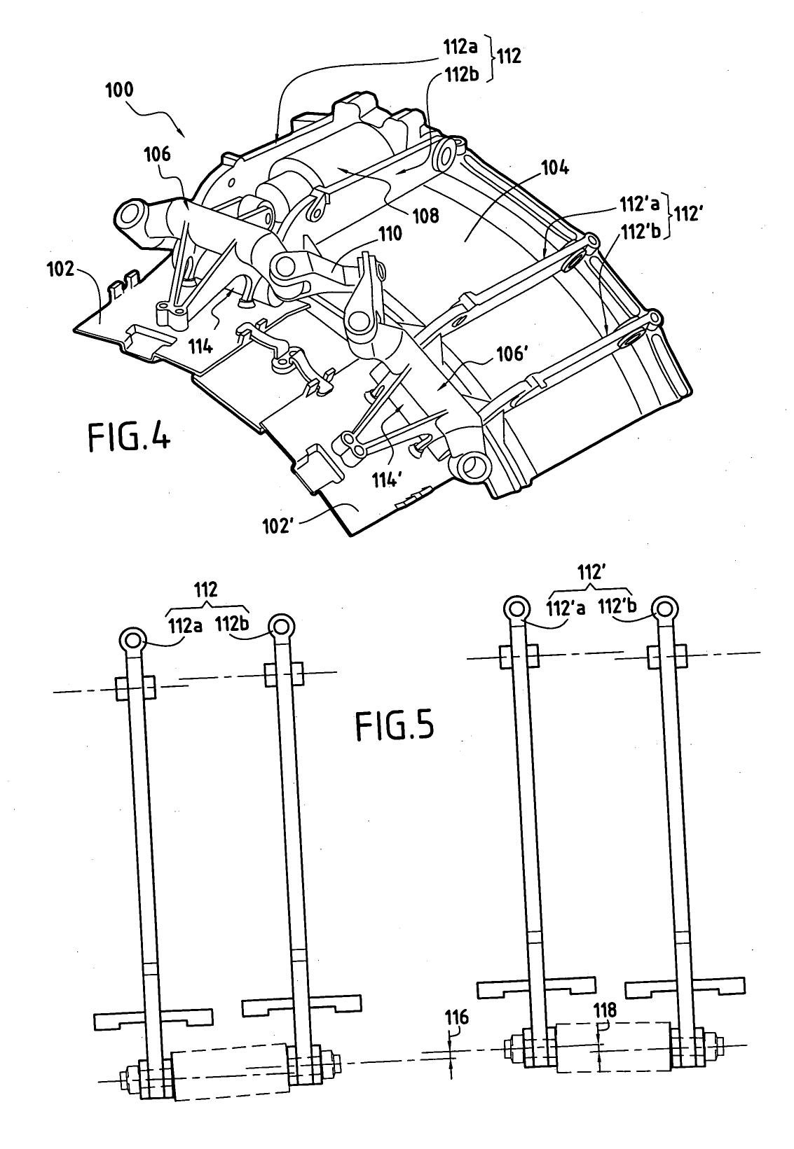

### DETAILED DESCRIPTION OF AN EMBODIMENT FIG. 1 shows a portion of a turbomachine variable-section nozzle 10 of the invention.

The nozzle 10 of axis X-X comprises in particular a plurality of controlled moving flaps 12 and follower moving flaps 13 which are mounted on a downstream end of an annular casing 14 of the turbomachine, which casing is centered on the axis X-X. The controlled and follower flaps 12 and 13 thus form a ring.

The controlled moving flaps 12 are actuated directly by control means in such a manner as to modify the profile of the primary stream from the turbomachine (i.e. its exhaust section).

The control means for the controlled flaps 12 comprise control -levers 16, each associated with a respective moving flap 12, and at least one actuator 18 for actuating the control levers. Each lever is secured to the moving flap 12 that it controls.

In the example of FIG. 1, it can be seen that only one actuator 18 is needed to actuate two control levers 16 simultaneously. Other configurations can also be envisaged (one actuator per control lever, for example).

Swivelling-fork type connections 20 interconnect the control levers 16 so as to synchronize the displacement of the moving flaps 12. In particular, when a single actuator 18 actuates two control levers 16 simultaneously, the connections 20 enable drive to be transmitted from the actuated lever to the follower lever.

The follower flaps 13 are disposed radially inside the control flaps 12 and bear against the adjacent control flaps. They thus serve to ensure leakproofing continuity for the primary stream while the nozzle is in operation, with this applying regardless of the section of its opening.

The nozzle 10 also has a plurality of pairs of arms 22 (or splints) each forming a support for a control lever 16. Each control lever support 22 essentially comprises two substantially parallel arms 22a, 22b extending along the axis X-X of the nozzle.

The two arms 22a, 22b of each support 22 have their upstream ends secured to the casing 14 of the nozzle 10 via screws (not shown) that are received radially in orifices 24.

Furthermore, tabs 26 are also formed at the upstream end of each arm 22a, 22b of a given support 22. Such tabs are received in a circumferential groove 28 of the casing 14 so as to hold the support 22 axially relative to the casing.

At their downstream ends, the arms 22a, 22b of each support 22 form respective L-shapes, and are connected to one of the control levers 16 via a spool 30. The spool 30 is secured between the downstream ends of the two arms 22a, 22b of the supports 22 by screw-and-nut type systems (not shown).

In the invention, each pair of arms 22 forming a control lever support is formed as a single piece. As shown in FIGS. 2 and 3, the control lever supports 22 constitute single pieces. They can be obtained, for example, by casting, or by welding together two arms, or indeed by being machined out from a solid.

The arms 22a, 22b of a given support 22 are interconnected transversely at their downstream ends by a downstream spacer 32 that is formed integrally with the support arms (FIGS. 2 and 3).

More precisely, the downstream spacer is formed by a tongue 32 extending radially towards the inside of the casing and including a plurality of holes 34. The tongue is thus designed to be received in a circumferential groove (not shown in FIG. 1) formed in the casing, the holes 34 serving to allow fastener systems to pass for fastening the support 22 to the casing.

FIG. 2 shows an embodiment of the invention of a control lever support 22 for co-operating with a control lever that is not actuated directly by an actuator.

As shown in FIG. 2, such a control lever support 22 advantageously includes an upstream spacer 36 extending between the upstream ends of each of the arms 22a, 22b of making up the support. Such an upstream spacer 36 serves to stiffen the control lever support 22. In the example shown in this figure, the upstream spacer 36 extends transversely between the fastening orifices 24 for fastening the arms 22a, 22b to the casing.

FIG. 3 shows another embodiment of a control lever support 22. This support is intended more specifically for co-operating with a control lever that is actuated directly by an actuator.

In this embodiment, the support 22 also has an upstream spacer 36′ for providing overall stiffening. However this upstream spacer 36′ is smaller in section than the spacer in the embodiment of FIG. 2.

Given that the support 22 is for co-operating with a control lever that is actuated directly by an actuator, it is less stiff than the support of FIG. 2 that does not have an actuator so as to enable it to be clamped in one direction against the actuator.

Whatever the shape of the upstream spacer transversely interconnecting the upstream ends of the arms in each control lever support, the spacer is naturally preferably formed integrally with the arms and the downstream spacer of the support.

With reference to FIG. 1, it should be observed that the actuators 18 of the control levers 16 are mounted on the casing 14 between the two arms 22a and 22b of a single control lever support 22.

What is claimed is:

1. A variable-section nozzle for a turbomachine, the nozzle comprising a plurality of moving flaps mounted on the downstream end of an annular casing of the turbomachine, a moving flap control system comprising control levers each associated with a respective moving flap and at least one actuator for actuating the control levers, and a plurality of pairs of arms each forming a control lever support, the arms of each support being secured both to the casing and to a control lever, wherein each pair of arms forming a control lever support is formed as a single piece.

2. A nozzle according to claim 1, wherein each control lever support further comprises an upstream spacer secured between the upstream ends of each arm of the support.

3. A nozzle according to claim 2, wherein the upstream spacer of each control lever support is formed integrally with the arms of said support.

4. A nozzle according to claim 1, wherein said at least one actuator is mounted on the casing via one of the control lever supports.

5. A support for a control lever of a moving flap of a turbomachine variable-section nozzle according to claim 1.
